(19) United States
(12) Patent Application Publication
(10) Pub. No.: US 2022/0011082 A1
(43) Pub. Date: Jan. 13, 2022

(54) Tail Piece for Remote Delivery Device ( CIP of Application 15/932.942 filed 05/24/2018)

(71) Applicant: Blair D. Soars, Williamsport, PA (US)

(72) Inventor: Blair D. Soars, Williamsport, PA (US)

(73) Assignee: Pneu-Dart

(21) Appl. No.: 16/873,799

(22) Filed: Jul. 10, 2020

(51) Int. Cl. F42B 12/54

(52) U.S. Cl. CPC F42B 12/54; A61D 7/00

(57) ABSTRACT

A remote delivery device is disclosed which has a tubular body and a tubular tail piece. The tubular body is crimped onto said tail piece at a desired axial position with a rearmost edge of the body abutting the protrusions at only contact segments of the rear-most edge. With the provision of spaced-apart protrusion on the tail piece, axial expansion of said tubular body caused by a crimping operation imparts less stress and axial force on the tail piece as compared to stress and force which would be imposed upon a tail piece which has a singular annular abutment extending around an entire circumference of said tail piece. This results in reducing a rate of failure of said tail piece breaking off from said body when the remote delivery device is subjected to outside stresses or forces and allows for the use of a wider range of acceptable crimp lengths.

This application is a continuation-in-part of U.S. patent application Ser. No. 15/932,924, filed May 24, 2018.

### BACKGROUND OF THE INVENTION

### 1. Field of the Invention

The present invention relates to an improved tail piece for a remote delivery device best known as a Dart (hereinafter “RDD”) and method of attaching the same. More specifically, it relates to a tail piece having an improved structure which is crimped to a main tubular body of an RDD in a manner which reduces stress on the tail piece thereby reducing occurrences of the tail piece breaking off from the main body.

### 2. Description of the Prior Art

The state of the prior art is set forth in applicant's earlier U.S. Pat. No. 9,234,729 issued Jan. 12, 2016 for “Improved Injection Dart” which patent is hereby incorporated herein by reference thereto. In U.S. Pat. No. 9,234,729 applicant described an injection dart which provided a flow restrictor to control the rate of flow of an injection from such a device to reduce tissue damage. The various references cited in such patent are still believed to provide a current view of the state of the art with respect to RDDs.

All RDDs include a main body into which the injectable liquid to be dispensed is loaded. With smaller RDDs (one typically utilized to dispense from 0.5 to 2 cc. of medication) the main body is preferably formed of plastic resin and with larger RDDs (utilized to dispense from 3 cc. to 10 cc. of injectable liquid) the main body of the RDD is preferably formed of aluminum. The main components of a typical RDD include a stainless cannula, gelatin collars, an aluminum nose cone, a plastic resin or aluminum main body and a plastic resin tail piece and such components are well known in the art.

The accuracy of an RDD when discharged or shot from a projector (whether it be a gauged CO2 projector, a cartridge fired projector or a compressed air projector) is highly dependent upon the manufacturing precision of the RDD components and their assembly.

One form of a commercially available RDD utilizes an aluminum tubular body which has a rear end crimped onto a plastic resin tubular tail piece. The tail piece includes an annular abutment which fully encircles the reward portion of the tail piece. During assembly, a forward end of the tail piece is inserted into the rear end of the aluminum body to the location of the annular abutment and the body is crimped onto the tail piece. If the tail piece and the body are in perfect axial alignment, the crimping operation generally is effective in forming a strong bond and connection between such components.

However, in some instances, if the tail piece and the body are not in perfect axial alignment, the crimping operation causes an axial deformation of the rear end of the aluminum body which pushes against the annular abutment with considerable force. Because the annular abutment fully encircles the tail piece, the rearmost end of the aluminum body it in direct contact with and abuts the annular abutment around the entire circumference of the annular abutment. In this configuration, any rearward axial deformation of the body against the annular abutment applies pressure all the way around the tail piece.

In some instances, this pressure causes the plastic resin tail piece to be put under stress such that the tail piece can break off from the body over time. Such a failure, even though the rate of failure is not high, is undesirable and there remains a need from an improved RDD which has a tail piece connected to a main body in a manner which causes less stress upon the tail piece and is less likely to have the tail piece break off from the body.

### SUMMARY OF THE INVENTION

This invention relates to a remote delivery device comprising a tubular body and a tubular tail piece, said plastic resin tail piece adapted to telescope part way into body, said plastic resin tail piece having a plurality of radially extending spaced-apart protrusions provided at a desired axial position, said spaced-apart protrusions abutting with and in contact with only certain segments of a rear-most tubular body surface. The protrusions extend radially outwardly beyond an inside diameter of said body and the tubular body is crimped onto said tail piece at a desired axial position. The rear-most edge of said body abuts and is in contact with said protrusions only at the location of certain segments of said rear-most edge of the body and not around the entire circumference of the rear-most edge as is the case the with prior art.

Preferably axial expansion of said body caused by a crimping operation imparts less stress and axial force on said tail piece as compared to stress and force which would be imposed upon a tail piece having a singular annular abutment extending around an entire circumference of said tail piece whereby reducing a rate of failure of said tail piece breaking off from said body when subjected to the imposed stresses of an irregular crimp condition or outside forces.

Said outside forces may be caused by a discharge of said remote drug delivery device from a projector into an animal or target or by shipping or handling of the RDD.

Preferably, said tail piece includes an annular O-Ring groove into which a rear end of said body is crimped over and around an installed O-Ring. The annular groove includes a rearward facing solid wall surface, a groove floor surface having an outer diameter less than an outer diameter of said forward tail end, and a partial forward-facing wall comprised of said spaced-apart protrusions. Preferably, said partial forward-facing wall comprises spaced-apart protrusions which, in combination, extend around about 50% said circumferential surface of said tail piece. Preferably, said protrusions comprise four spaced-apart protrusion, with each protrusion extending approximately 45 radial degrees symmetrically around said tail piece thus providing four spaced apart radial contact segments of said rear-most edge of the body where said protrusions abut and are in contact with said rearmost edge of said main body. This configuration of the protrusions creates four spaced apart radial gaps between the contact segments, where no such contact occurs.

Preferably, partial forward-facing wall comprises protrusions which in combination extends around between 30% and 70% of said circumferential surface of said tail piece.

Preferably, said main body is formed of aluminum and said tail piece is formed of formed of plastic resin.

In one form of the invention, a remote delivery device is provided comprising:

a) a tubular body having a forward body end and a rear body end; and

b) a tubular tail piece inserted into said rear body end of said tubular body said body having a rear end thereof mechanically crimped onto said tail piece to secure said tail piece to said body, said tail piece having tubular forward tail end having an outer diameter smaller than an inner diameter of said rear body end allowing said forward tail end to be inserted into said rear body end, said forward tail end also including a plurality spaced-apart protrusions around an outer circumferential surface of said tail piece defining a rearmost portion of said forward tail end, said protrusions having an outer diameter larger than said inner diameter of said rear body end, said tail piece being crimped at a desired axial position relative to said body, said protrusions having a forward protrusions surface forming a partial forward-facing wall which collectively abuts a rearmost edge of said rear body end at about 50% of the circumference of said rearmost edge whereby stress on said tail piece caused by axial expansion of said rearmost edge is reduced.

Reserved

### BRIEF DESCRIPTION OF THE FIGURES

FIG. 1 is a side elevational view of the remote delivery device of the present invention including an improved tail piece.

FIG. 2 is a side elevational view of the remote delivery device with a stabilizer support flange and flight stabilizer attached.

FIG. 3 is a perspective view of the remote delivery device of FIG. 2.

FIG. 4 is an exploded perspective view showing a body and tail piece having spaced-apart protrusions according to the present invention.

FIG. 5a is a side elevational view of a prior art remote delivery device including an annular abutment which extends around the entire circumference of the tail piece.

FIG. 5b is an end elevational view of the prior art RDD of FIG. 5a.

FIG. 5c is a perspective view of the prior art RDD of FIG. 5a.

FIG. 6a is a side elevational view of the improved tail piece of the present invention including a plurality of spaced-apart protrusions.

FIG. 6b is an end elevational view of the RDD of FIG. 6a.

FIG. 6c is a perspective view of the RDD of FIG. 6a.

FIG. 7 is a perspective view of the improved tail piece of the present invention with an RDD body crimped onto the tail piece.

### DETAILED DESCRIPTION OF THE PREFERRED EMBODIMENTS

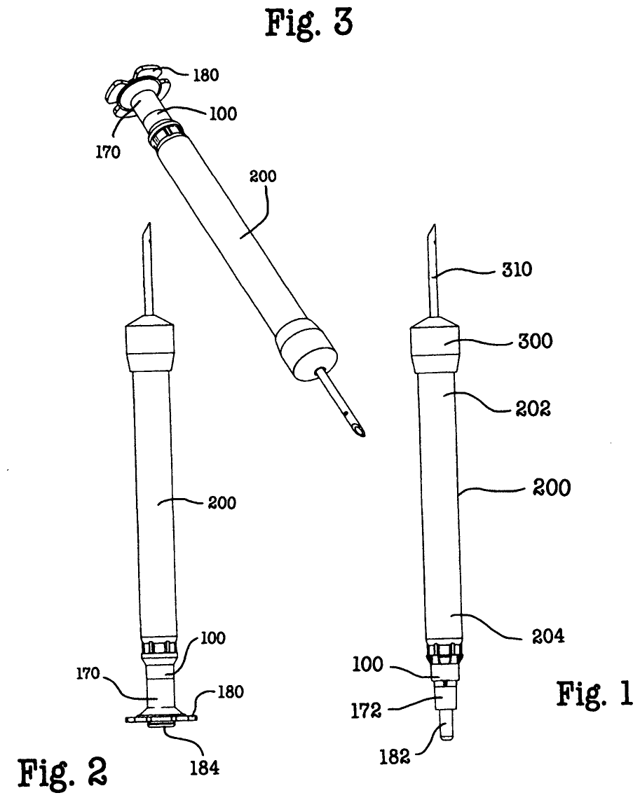

Referring to FIG. 1, a side elevational view of a typical partially assembled remote delivery device of the type for which the present invention is best intended. This device includes a tubular body 200 preferably formed of aluminum. The body 200 includes a forward end 202 and rear end 204. A forward end cap 300 is provided into which a cannula 310 is mounted. The body 200 contains a reservoir into which a desired injectable liquid to be dispensed is stored by means well known in the art. FIG. 1 also shows an improved tail piece 100. Tail piece 100 includes a tail piece portion 172 on which a stabilizer support flange 170 is mounted and an end post portion 182 which is utilized to secure a stabilizer 180.

Referring to FIGS. 2 and 3, a fully assembled remote delivery device is shown to illustrate the overall design of such devices. In addition to the components shown above in FIG. 1, this view also shows the location of a stabilizer support flange 170 and stabilizer 180. The post forward end portion 182 of the tail piece 100 is mounted or otherwise formed into a button 184 which secures the stabilizer 180 onto the rear end 204 of the RDD.

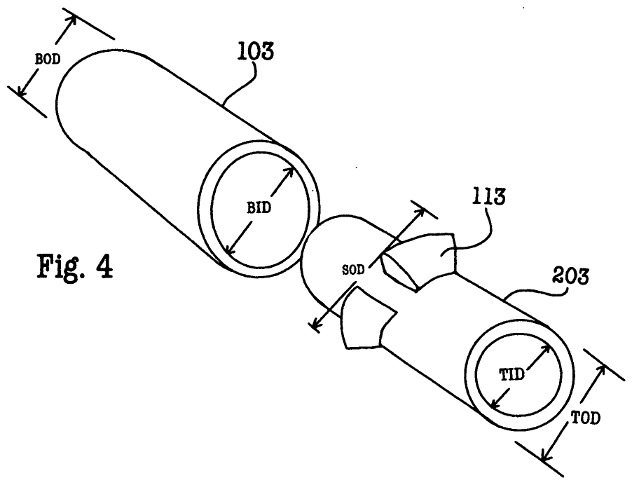

FIG. 4 shows an exploded view of the tubular body 103 and a tubular tail piece 203 according to the present invention. The tubular tail piece 203 includes a plurality of radially extending protrusions 113. The tubular body 103 includes a body inner diameter (BID) and a body outer diameter (BOD). The tail piece 203 includes a tail piece inner diameter (TID) and a tail piece outer diameter (TOD). Obviously, for the tail piece to telescope into the body, the TOD must be smaller than the BID. Protrusions 113 extend radially outward from the tail piece. For the protrusions 113 to function properly, the protrusion outer diameter (POD) must be larger than the BID and is also preferably larger than the BOD. In this way, the forward end of the tail piece can be inserted into the body 103 only to the location of the protrusions 113. Once the tail piece is inserted into tubular body 103 to a desired axial location, the body is then crimped onto the tail piece by means well known in the art.

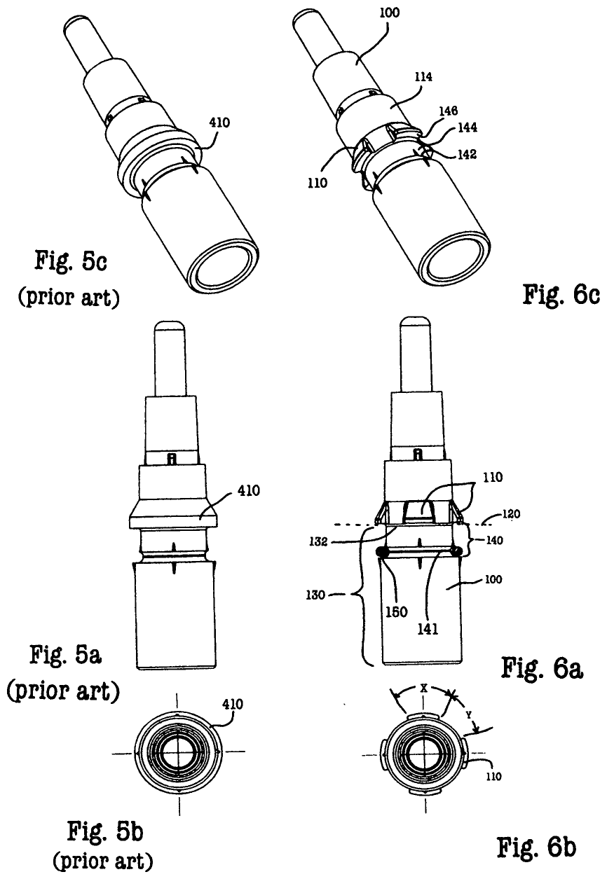

Referring to FIGS. 5a, 5b and 5c, a prior art tail piece is shown. This tail piece is identical to the improved tail piece shown in FIGS. 6a, 6b and 6c except a singular annular abutment 410 of the prior art fully encircles the tail piece whereas the radially extending protrusions 110 of the present invention are provided only at spaced-apart locations around the circumference of the tail piece. Referring more specifically to FIG. 6a, the tail piece 100 includes a plurality radially extending protrusions 110 provided at spaced-apart locations around the tail piece. A desired axial position is shown at 120. As shown, the tail piece has a forward end portion 130 which is designed to be inserted into a body of an RDD. The portion 130 has a rearmost end 132 located at the desired axial position 120. Preferably, the tail piece includes a groove 140.

Referring to FIG. 6c, the groove 140 includes a rearward wall surface 142, a groove floor 144 and a partial forward-facing portion or forward protrusion surface 146 created by the protrusions 110. The protrusions 110 are provided on and extend radially outward from an outer circumference 114 of the tail piece 100. [0032] As best shown in FIG. 6b, the protrusions 110 each extend a radial distance X around the circumference and the space or gap between the protrusions extend a radial distance Y. Preferably, only four (4) protrusions are provided around the circumference of the tail piece. When this is the case as is shown in FIG. 6b, the radial distance X will be equal to 45° and the radial distance Y will also be equal to 45°. It will be obvious to those skilled in the art that if one wished to provide eight (8) protrusions, for example, rather than four (4) protrusions, then each of these radial distances would be half as long, namely 22.5°. FIG. 6b also shows the location of an O-ring 150 (shown in section) which is seated in a shallow U-shaped channel 141 provided in a rearward portion of groove 140.

Additionally, although it is preferred that the present invention include protrusions 110 which extend around approximately 50% of the circumference of the tail piece, applicant has discovered that the invention provides a reduction in stress to the tail piece if the protrusions 110 extend anywhere from 30% to 70% of the distance around the circumference. For example, if the protrusions members were provided each member having a radial distance of 27° and each protrusion being spaced-apart by a radial distance Y of 63° then such an arrangement would provide protrusions which extend around 30% perimeter or circumference of the tail piece 100. Alternatively, if four (4) protrusions were provided each extending a radial distance X of 63° with a space or gap between them of Y being equal to 27°, in this instance, the protrusions 110 would extend around 70% the perimeter. It will be obvious to those skilled in the art that the number of protrusions and the gap or distance between them can be varied in many ways but in order for the present invention to significantly reduce stress on the tail piece it is believed that protrusions extending between 30° and 70° around the perimeter is required with protrusions extending around 50% of the circumference being considered ideal.

As will be well understood, the provision of a groove 14 shown in FIGS. 6a, 6b and 6c, provides a space into which the installed O-Ring 150 can seat itself and the metal of the rear end of the body may be crimped providing a sealed and aerodynamic RDD.

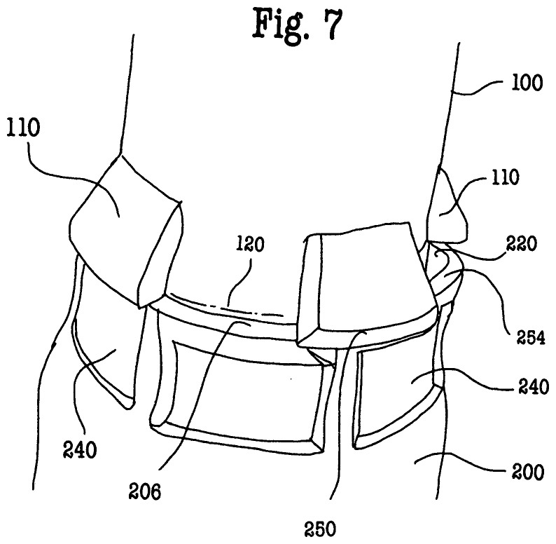

Referring to FIG. 7 the material (typically aluminum) of the body is crimped at spaced apart locations 240 around the perimeter of the rear end of the body 204 to affix the tail piece 100 onto the body 200. As shown, the rearmost edge 206 of the body 200 is in contact with the protrusions 110 only at some radial contact segments designated 250. There are also radial gaps 254 where the rearmost edge 206 of the body does not contact the protrusions 110 at all. It is this lack of contact that is believed to result in a reduction of stress to the tail piece 100. As can be seen, the protrusions 110 must extend radially outward at least beyond the inside surface 220 of the main body. Because the crimping operation may cause some degree of axial expansion of the metal at the location of the rearmost edge 206 of the body, providing spaces or radial gaps 254 where the body does not contact the protrusions 110 is believed to result in a reduction in this axial force on the tail piece and decrease the rate of failure of a tail piece 100 breaking off from the body 200 under stress.

In practice, prior to the present invention, a single annular abutment 410 which fully encircled the tail piece as shown in FIGS. 5a, 5b and 5c with utilized. With this prior art annular abutment, the rearmost edge 206 of the body would be abutting and in contact with the annular abutment all the way around the entire perimeter of the annular abutment 410 and all rearward axial forces imparted by a crimping operation would be directed into the annular abutment 410 increasing the stress on the tail piece.

While this change might at first appear somewhat trivial, it has a real and unexpected benefit in practice. The art of manufacturing remote delivery devices is a very difficult process which requires precise manufacturing tolerances. An RDD is a complex device which is literally shot from a projector at a high velocity, flies through the air and into the body of an animal and then dispenses an injectable liquid at a controlled rate. The mechanics of such a device is highly technical and the amount of force which the RDD is subject to especially during the actual discharge from the projector is enormous. By providing an RDD which has a tail piece which is less likely to break off greatly increases the effectiveness of the device and allows for increased performance for both the animal to which medications need to be administered and to the operators who discharges the projector and delivers the RDD into the animal.

While not specifically mentioned earlier, it is highly desirable that the protrusions 110, regardless of the number be provided, be arranged in a symmetrical pattern around the circumference of the tail piece. Because these devices are designed for accurate flight, having a symmetrical design is believed to be highly advantageous.

Applicant has significant experience in the manufacturing of various type of remote delivery devices for injecting animals from a distance away. For reasons then unknown to applicant, a significant number of devices were discovered to have tail pieces which had cracked or broken completely off the tubular body of the RDD. Applicant speculated that an excessive amount of tensile or other stress was being placed upon the tail piece either by the crimping operation or in subsequent use of the RDDs in the field.

Applicant conceived of the new design of FIG. 6 and conducted exhaustive testing comparing the failure rate of the new FIG. 6 design against the prior art design of FIG. 5. Literally hundreds of components of the RDDs were precisely measured including three separate measurements of the length of each crimp and three separate measurements of the diameter of each crimp. As used herein the term “crimp length” is intended to refer to the distance of the closest crimp indentation to the rearmost edge 206 of the tubular body. The number of failures of each RDD was checked at four-month, six-month, nine-month, ten-month and nineteen-month intervals.

Sets of fifty production models each of the FIG. 5 (having a single annular abutment 410) and FIG. 6 (having radially extending protrusions 110) configurations were tested with crimp lengths in the ranges of: Group 1 having a crimp length of 0.093″-0.100″; Group 2 having a crimp length of 0.101″-0.105″; Group 3 having a crimp length of 0.106″-0110″; and Group 4 having a crimp length of 0.111″-0.115.″

Interestingly, applicant discovered by means of this exhaustive testing process that there were no failures of the production RDDs of either type in the Group 1, 2 and 3 tests at any of the testing intervals. However, in Group 4, out of the fifty FIG. 5 type RDDs (having a single annular abutment), there were 21 failures at four months and an additional failure at six months. By comparison, the FIG. 6 design had only a single failure at six months. While applicant does not know with certainty the reason the new design with radially extending protrusions rather than a single annular abutment has significantly fewer failures, it is speculated the gaps between the radially extending protrusions provide elasticity Vs. the rigidity of a singular annular surface which allows for elevated elastic potential of the plastic resin during the crimping operation which reduces the amount of tensile stress at the point of contact between the rear most edge of the body and the tail piece protrusions.

As will be obvious to those skilled in the art, the manufacturing and production of RDDs which can withstand stresses caused by manufacturing and in use requires great precision and a very narrow range of tolerances in order to provide reliable product. As shown from the test results above, a variation in the location and length of the crimp of only 0.001″ to 0.005″ resulted in a failure rate of 44% of the prior art design. Applicant's invention reduced this failure rate to only 2% at the highest crimp dimensions. Only for the purpose of interpreting the claims of this application, a failure rate of more than 5% is considered to be a significant rate of product failure (obviously, in the market place this term would be defined differently and at a much lower percentage). The use of radially extending protrusions to reduce tensile stress and to greatly reduce tail piece failures in RDDs is far from obvious and was only verified by extensive testing. For example, had applicant only tested Groups 1, 2 and 3 and not Group 4, applicant may well have concluded that the radially extending protrusions provided no benefit or improvement over the prior art. It was only through such a through and time-consuming testing process that applicant was able to conclude that the new design does indeed provide a significant improvement over the prior art.

Applicant has also recently conducted additional testing regarding the speculation set forth above. This latest round of testing involved the testing of ten RDD samples of the new design having gaps between the radially extending protrusions. Each sample was initially measured from the tips of the protrusion to the ridge on which the slip on tail rests. The tails were then rotated 90° and measured again. Their lengths were recorded. The tails were then crimped long (i.e. a Group 4 arrangement) to ensure that there was greater than normal stress and the crimp lengths recorded. The tails were then remeasured as they were before and the post crimp length recorded. The analysis of this testing was that the tips of the segmented protrusions moved on average 0.0017″ away from the crimp. The aluminum was also observed to be moving around the sides of the segmented protrusions. This latest round of testing additional data and support data for the theory in that the protrusion is absorbing the crimp energy along with the concept the rearward edge of body is permitted the freedom to creep into the segmented space between each protrusion. In summary, the latest data provides additional support for applicant's theory that multiple radial protrusions spaced equally apart, allows for elevated elastic potential of the resin and provides freedom for the rearward edge of body to creep into the segmented space between each radially spaced protrusion thereby reducing the cumulative stress placed on the part. This is the best explanation supported by all the testing and data as to how and why applicant's new RDD design has a greatly reduced rate of failure over a variety of crimping conditions.

It is to be understood that while certain forms of the present invention have been illustrated and described herein, the present invention is not to be limited to the specific forms or arrangements of parts described and shown.

I claim:

1. A remote delivery device comprising a tail piece and a tubular body rigidly crimped onto said tail piece, said tail piece having a plurality of radially extending spaced-apart protrusions, said spaced-apart protrusions abutting and in contact with only contact segments of a rear-most tubular body edge.

2. A remote drug delivery device according to claim 1 whereby axial expansion of said tubular body caused by a crimping operation imparts less stress and axial force on said tail piece as compared to stress and force which would be imposed upon a tail piece having a singular annular abutment extending around an entire circumference of said tail piece whereby reducing a rate of failure of said tail piece breaking off from said body when said remote delivery device is subjected to outside stresses or forces.

3. A remote delivery device according to claim 1 wherein a partial forward-facing wall comprises spaced-apart protrusions which, in combination, extend around about 50% said circumferential surface of said tail piece.

4. A remote delivery device according to claim 3 wherein said protrusions comprise four spaced apart protrusions, each protrusion extending 45 radial degrees symmetrically around said tail piece thus providing four spaced apart radial contact segments where said protrusions contact a rearmost edge of said main body and four spaced apart radial gaps where no such contact occurs.

5. A remote delivery device according to claim 1 wherein a partial forward-facing wall comprises spaced apart protrusions which, in combination, extend around between 30% and 70% of said circumferential surface of said tail piece.

6. A remote delivery device according to claim 1 wherein said main body is formed of aluminum.

7. A remote delivery device according to claim 1 wherein said tail piece is formed of formed of plastic resin.

8. A remote delivery device comprising:
a) a tubular body having a forward body end and a rear body end; and
b) a tubular tail piece inserted into said rear body end of said tubular body,
said body having a rear end thereof mechanically crimped onto said tail piece to secure said tail piece to said body, said tail piece having tubular forward tail end having an outer diameter smaller than an inner diameter of said rear body end allowing said forward tail end to be inserted into said rear body end, said forward tail end also including a plurality of radially extending spaced-apart protrusions located at spaced-apart locations around an outer circumferential surface of said tail piece, said protrusions having an outer diameter larger than said inner diameter of said tubular body, said tail piece being crimped at a desired axial position relative to said body, said spaced-apart protrusions having a forward protrusion surface forming a partial forward-facing wall which collectively abuts a rearmost edge of said rear body end at radial contact segments of about 50% of the circumference of said rearmost edge whereby stress on said tail piece caused by axial expansion of said rearmost edge is reduced.

9. A remote delivery device comprising a tail piece and a tubular body rigidly crimped onto said tail piece, said tail piece having a plurality of radially extending spaced-apart protrusions, said spaced-apart protrusions abutting and in contact with only contact segments of a rear-most tubular body surface whereby allowing the crimping to occur at a wider range of crimp lengths without significant product failure.

10. A remote delivery device according to claim 8 wherein crimp lengths in group 1 which has a crimp length of 0.093″-0.100″; group 2 which has a crimp length of 0.101″-0.105″; group 3 which has a crimp length of 0.106″-0110″; and group 4 which has a crimp length of 0.111″-0.115″ can be made without a significant rate of failure.
